(19) United States
(12) Patent Application Publication
(10) Pub. No.: US 2012/0258285 A1
(43) Pub. Date: Oct. 11, 2012

(54) SUBSTRATE FOR FABRICATING LIGHT EMITTING DEVICE AND LIGHT EMITTING DEVICE FABRICATED THEREFROM

(75) Inventor: Chih-Ching Cheng, Taichung City (TW)

(73) Assignee: HUGA OPTOTECH INC., Taichung City (TW)

(21) Appl. No.: 13/527,598

(22) Filed: Jun. 20, 2012

Related U.S. Application Data
(63) Continuation-in-part of application No. 12/453,409, filed on May 11, 2009.

(30) Foreign Application Priority Data
Jul. 14, 2008 (TW) 097126565

(51) Int. Cl. B32B 3/30

(52) U.S. Cl. 428/156

(57) ABSTRACT

The invention provides a patterned substrate for fabricating a light emitting device having an improved surface structure and the light emitting device fabricated therefrom. The patterned substrate includes at least one platform region having a first facet direction for epitaxial growth; and a plurality of directly adjacent protruded portions surrounding the at least one platform region to isolate the at least one platform region from another platform region, wherein facet direction of each scattering surface of the plurality of directly adjacent protruded portions is substantially excluded from first facet direction. Since facet direction of each scattering surface of the plurality of directly adjacent protruded portions substantially do not include the first facet direction, during formation of the light emitting device, epitaxial growth is mainly conducted on the at least one platform region, which may prevent epitaxial defects from generating and enhance external quantum efficiency of the light emitting device.

### CROSS-REFERENCE TO RELATED APPLICATION

This application is a continuation-in-part of and claims the priority benefit of U.S. application Ser. No. 12/453,409, filed on May 11, 2009, now pending, which claims the priority benefit of Taiwan application serial no. 097126565, filed on Jul. 14, 2008. The entirety of each of the above-mentioned patent applications is hereby incorporated by reference herein and made a part of this specification.

### FIELD OF THE INVENTION

The present invention relates generally to a substrate for fabricating a light emitting device and the light emitting device fabricated therefrom. More particularly, the present invention relates to a patterned substrate for fabricating a light emitting diode (LED) and the LED with high light extraction efficiency fabricated therefrom.

### BACKGROUND OF THE INVENTION

In recent years, a light emitting device, or a light emitting diode (LED), has been widely used in the applications such as back lights of displays or lighting, since LED has certain advantages of high luminance and “environmentally friendly”. However, for one skilled in the art, it is generally known that the poor quantum efficiency (external or internal) of LED may result in transferring the energy which has not been successfully converted into light into heat, and if the heat has not been properly dissipated from LED effectively, it may subsequently result in raising the temperature of LED and reducing the light emitting efficiency.

Generally, during the epitaxial growth of LED, if the epitaxial film contains large amount of dislocation, the internal quantum efficiency will be decreased. The internal quantum efficiency is proportional to light generated from the emitting layer, and the internal quantum efficiency is up to 100% for an ideal situation. The external quantum efficiency is the ratio of light outputting LED to light generated from the emitting layer.

To effectively enhance the external quantum efficiency, it is generally known for one skilled in the art to use a patterned substrate as a substrate for epitaxial growth. With reference to FIG. 6, light generated from the emitting layer of the epitaxial film substantially propagating along the plane of the film is directed to a direction perpendicular to the plane of the film resulted from the structure of the patterned substrate, and the light extraction efficiency is thus enhanced.

However, as shown in FIGS. 5A to 5D, the patterned substrate has two surfaces (40, 40′) for growing the epitaxial film. For a hexagonal single crystal structure of a C-plane sapphire substrate, the epitaxial film is primarily grown along the Miller index (0001) facet of the C-plane sapphire substrate, and almost not grown along the other facets. Therefore, since there are two surfaces (40, 40′) for growing the epitaxial film, when the patterned substrate 41 is used to grow the epitaxial film by a lateral epitaxial growth technique, the laterally grown epitaxial film 42′ will usually be formed with interval defects 48 on top of the trench. When light travels through these interval defects with irregular shapes, light will be directed into and restricted within the defects so as to reduce the external quantum efficiency.

Besides, since light scattering caused by the increasing of the different scattering surfaces of the protruded areas so as to increase the refractive angles when light travels to the patterned substrate, if the protruded areas are increased, for example by connecting the protruded areas to increase the effective surface areas for refraction, the light extraction efficiency will also be increased.

Thus, a requirement still remains for a patterned substrate provided with one primary platform for epitaxial growth to prevent interval defects from generating and with increased the light extraction efficiency.

Solutions to these problems have been long sought but prior developments have not taught or suggested any solutions and, thus, solutions to these problems have long eluded those skilled in the art.

### SUMMARY OF THE INVENTION

An objective of the present invention is to provide a substrate for fabricating a light emitting device having an improved surface structure provided with a major growth platform to prevent interval defects from generating and having increased effective surface areas of the protruded portions for enhancing the light extraction efficiency.

The present invention provides a patterned substrate for fabricating a light emitting device having an improved surface structure, comprising: at least one platform region having a first facet direction for epitaxial growth; and a plurality of directly adjacent protruded portions surrounding the at least one platform region to isolate the at least one platform region from another platform region, each directly adjacent protruded portion having a scattering surface and a vertex, wherein facet direction of each scattering surface of the plurality of directly adjacent protruded portions is substantially excluded from first facet direction, wherein at least one unit region is surrounded by the vertexs or lines between the adjacent vertexs of the plural directly adjacent protruded portions, an area of the unit region consists of an area of the protruded portions and an area of the platform region, the area of the protruded portion is larger than the area of the platform region.

Preferably, each vertex of the plurality of protruded portions has a shape of dot or line.

Preferably, the scattering surfaces are formed between the platform region and the vertexs or lines between the adjacent vertexs of the plurality of directly adjacent protruded portions.

Preferably, the ratio of the area of the platform region to the area of the unit region is less than or equal to 10%.

Preferably, the plurality of directly adjacent protruded portions have a curved surface or a flat surface.

Preferably, the first facet direction is (0001) facet direction for C-plane sapphire.

Preferably, the unit region has a shape of hexagon or triangle.

The present invention further provides a patterned substrate for fabricating a light emitting device having an improved surface structure, comprising: at least one platform region having a first facet direction for epitaxial growth; and a plurality of directly adjacent protruded portions surrounding the at least one platform region to isolate the at least one platform region from another platform region, each directly adjacent protruded portion having a scattering surface and a vertex, wherein each facet direction of the scattering surface of the plurality of directly adjacent protruded portions is substantially excluded from first facet direction, wherein in top view of the area of the directly adjacent protruded portion for scattering light is larger than the area of the platform region for epitaxial growth.

Preferably, each vertex of the plurality of directly adjacent protruded portions has a shape of dot or line.

Preferably, the scattering surfaces are formed between the platform region and the vertexs or lines between the adjacent vertexs of the plurality of directly adjacent protruded portions.

The present invention further provides a patterned substrate for fabricating a light emitting device having an improved surface structure, comprising: at least one platform region serving as a primary platform for epitaxial growth; and a plurality of directly adjacent protruded portions surrounding the at least one platform region to isolate the at least one platform region from another platform region so as to enhance light extraction efficiency, each directly adjacent protruded portion having a scattering surface and a vertex, wherein at least one unit region is surrounded by the vertexs or lines between the adjacent vertexs of the plural directly adjacent protruded portions, an area of the unit region consists of an area of the protruded portions and an area of the platform region, the area of the protruded portion is larger than the area of the platform region.

Preferably, each vertex of the plurality of directly adjacent protruded portions has a shape of dot or line.

Preferably, the scattering surfaces are formed between the platform region and the vertexs or lines between the adjacent vertexs of the plurality of directly adjacent protruded portions.

Preferably, the unit region has a shape of hexagon or triangle. Preferably, the ratio of the area of the platform region to the area of the unit region is less than or equal to 10%

Certain embodiments of the invention have other aspects in addition to or in place of those mentioned above. The aspects will become apparent to those skilled in the art from a reading of the following description when taken with reference to the accompanying drawings.

### BRIEF DESCRIPTION OF THE DRAWINGS

Relevant embodiments of the present invention will be described in detail below with reference to the accompanying drawings, in which:

FIG. 1A is a perspective view of a preferred embodiment of the patterned substrate of the present invention.

FIG. 1B is a sectional view along lines 1B-1B′ of FIG. 1A.

FIG. 1C is a sectional view along lines 1C-1C′ of FIG. 1A.

FIG. 1D is a top view of FIG. 1A.

FIG. 2A is a perspective view of another preferred embodiment of the patterned substrate of the present invention.

FIG. 2B is a sectional view along lines 2B-2B′ of FIG. 2A.

FIG. 2C is a sectional view along lines 2C-2C′ of FIG. 2A.

FIG. 2D is a top view of FIG. 2A.

FIG. 2E is a top view of another preferred embodiment of the patterned substrate of the present invention.

FIGS. 3A to 3D are schematic diagrams showing a production flow of a preferred embodiment of the light emitting device of the present invention.

FIG. 4 is an enlarged sectional view of a preferred embodiment of the patterned substrate of the present invention.

FIGS. 5A to 5D are schematic diagrams showing a production flow of a conventional light emitting device.

FIG. 6 is a schematic diagram illustrating the optical paths of a patterned substrate.

### DETAIL DESCRIPTION OF THE PREFERRED EMBODIMENT

The following embodiments are described in sufficient detail to enable those skilled in the art to make and use the invention. It is to be understood that other embodiments would be evident based on the present disclosure, and that process and mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known configurations and process steps are not disclosed in detail.

In the following description, several examples are given to provide a thorough understanding of the patterned substrate of the invention.

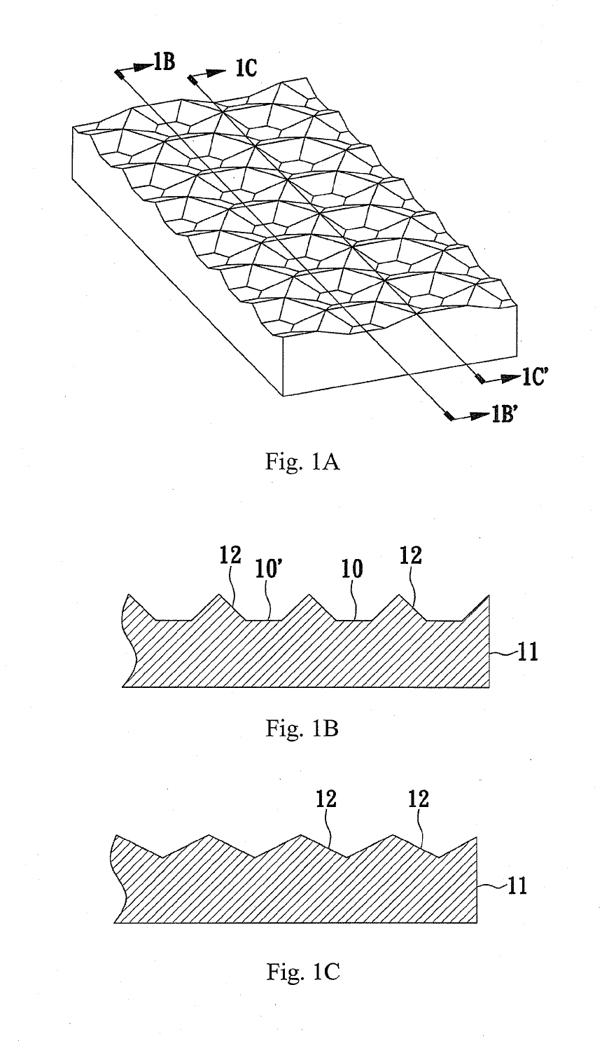

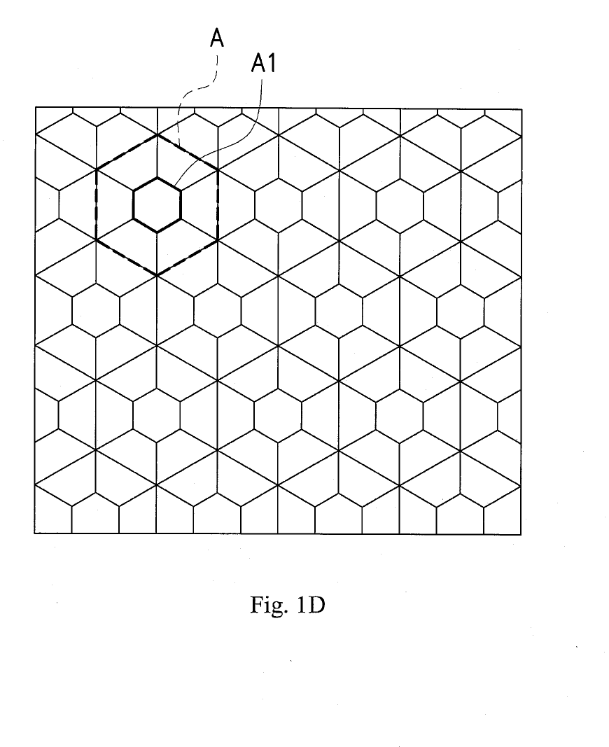

FIGS. 1A to 1C illustrate an embodiment of the patterned substrate of the invention. FIG. 1A is a perspective view of a preferred embodiment of the patterned substrate of the present invention. FIG. 1B is a sectional view along lines 1B-1B′ of FIG. 1A. FIG. 1C is a sectional view along lines 1C-1C′ of FIG. 1A.

With reference to FIG. 1A, the patterned substrate 11 for fabricating a light emitting device of the present invention comprises: at least one platform region 10 having a first facet direction for epitaxial growth, for example the (0001) facet direction of C-plane sapphire; and a plurality of directly adjacent protruded portions 12 surrounding the at least one platform region 10 to isolate the at least one platform region 10 from another platform region 10′, wherein facet direction of each scattering surface of the plurality of directly adjacent protruded portions 12 is substantially excluded from first facet direction. The plurality of directly adjacent protruded portions 12 have a flat surface. In FIG. 1A, each vertex of the plurality of directly adjacent protruded portions has a shape of line.

As shown in the sectional views FIG. 1B and FIG. 1C, the patterned substrate 11 primarily has a platform region 10 for growing epitaxial film, and the epitaxial film is formed primarily along the facet (0001) of C-plane sapphire and substantially not formed on other facets. Besides, the plurality of directly adjacent protruded portions 12 surround the at least one platform region 10 and engaged with each other, such that the effective surface areas of the patterned substrate 11 for refraction are maximized and the light extraction efficiency is remarkably increased.

FIG. 1D is a top view of FIG. 1A, wherein at least one unit region is surrounded by the vertexs of the plural directly adjacent protruded portions. As shown in FIG. 1D, the shape of the unit region as indicated by dotted lines is hexagon. The area of the unit region (the area of the outer hexagon) is A, the area of the platform region (the area of the inner hexagon) is A1, and the area of the protruded portions (the area between the outer hexagon and the inner hexagon) is A-A1.

In this embodiment, if each length of side of the outer hexagon is about 3 (μm), and each length of side of the inner hexagon is about 0.3 (μm). The area of the unit region (the area of the outer hexagon) A is about 23.383 (μm²), the area of the platform region (the area of the inner hexagon) A1 is about 0.234 (μm²), and the area of the protruded portions A-A1 is about 23.149 (μm²).

According to the calculation above, the area of the protruded portions A-A1 is larger than that of the platform region A1, and the ratio of the area of the platform region A1 to the area of the outer hexagon A is about 1%. In this embodiment, the area of the platform region (the major growth platform) is decreased to prevent interval defects from generating, and the area of the protruded portions (the effective area for refraction) is increased for enhancing the light extraction efficiency. Besides, for better epitaxial growth and better light extraction efficiency, the range of the length of side of the outer hexagon is about 3 (μm)˜15 (μm), and the range of the length of side of the inner hexagon is about 0.3 (μm)˜1.5 (μm). But the lengths of side of the outer hexagon and the inner hexagon are not limited thereto.

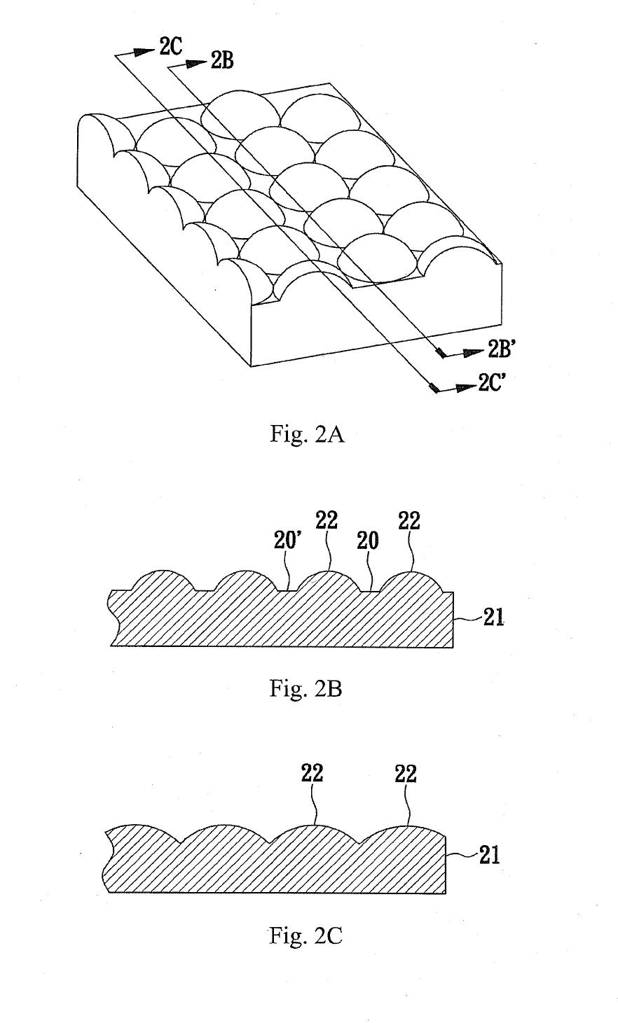

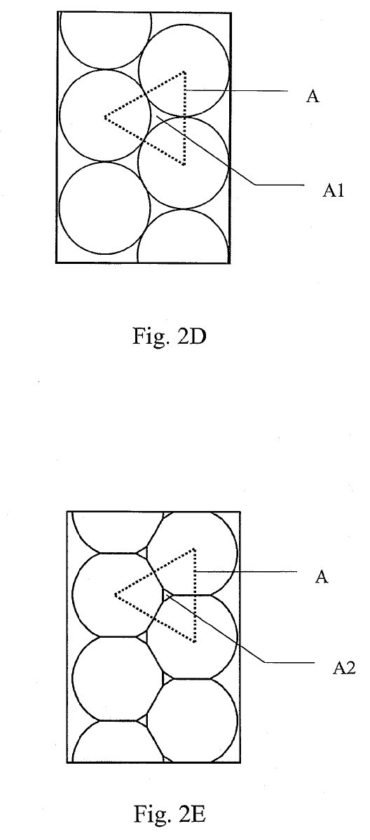

FIGS. 2A to 2C illustrate another embodiment of the patterned substrate of the invention. FIG. 2A is a perspective view of another preferred embodiment of the patterned substrate of the present invention. FIG. 2B is a sectional view along lines 2B-2B′ of FIG. 2A. FIG. 2C is a sectional view along lines 2C-2C′ of FIG. 2A.

With reference to FIG. 2A, the patterned substrate 21 for fabricating a light emitting device of the present invention comprises: at least one platform region 20 having a first facet direction for epitaxial growth, for example the (0001) facet direction of C-plane sapphire; and a plurality of directly adjacent protruded portions 22 surrounding the at least one platform region 20 to isolate the at least one platform region 20 from another platform region 20′, wherein facet direction of each scattering surface of the plurality of directly adjacent protruded portions 22 is substantially excluded from first facet direction. The plurality of directly adjacent protruded portions 22 have a curved surface. In FIG. 1A, each vertex of the plurality of directly adjacent protruded portions has a shape of dot.

As shown in the sectional views FIG. 2B and FIG. 2C, the patterned substrate 21 primarily has a platform region 20 for growing epitaxial film, and the epitaxial film is formed primarily along the facet (0001) of C-plane sapphire and substantially not formed on other facets. Besides, the plurality of directly adjacent protruded portions 22 surround the at least one platform region 20 and engaged with each other, such that the effective surface areas of the patterned substrate 21 for refraction are maximized and the light extraction efficiency is remarkably increased.

Further, FIGS. 2D and 2E illustrate an example of the patterned substrate of the present invention with increased protruded areas. FIG. 2D is a top view of FIG. 2A, wherein each vertex of the triangle as indicated by dotted lines is located in the center of a circle (the vertex of the hemisphere in FIG. 2A) of each of the directly adjacent protruded portions, and an unit region is surrounded by the lines between adjacent vertexs of the plural directly adjacent protruded portions (the triangle as indicated by dotted lines). The area of the unit region is A, the area of the platform region is A1, and the area of the protruded portions is A-A1. The area of the unit region A consists of the platform region (the major growth platform) A1 and the protruded portions (the effective area for refraction) A-A1.

In this embodiment, if the radius of circle is about 0.3 (μm), the area of the unit region A is about 0.156 (μm²), the area of the protruded portions A-A1 (the effective area for refraction) is about 0.141 (μm²), and the area of the platform region (the major growth platform) A1 is about 0.048 (μ²). Therefore, the area of the protruded portions A-A1 is larger than the area of the platform region A1, and the ratio of the area of the platform region A1 to the area of the unit region A is about 9.31%. For better epitaxial growth and better light extraction efficiency, the range of the radius of circle is about 0.3 (μm)˜4 (μm), but the radius of circle is not limited thereto.

In this embodiment, the area of the platform region (the major growth platform) is decreased to prevent interval defects from generating, and the area of the protruded portions (the effective area for refraction) is increased for enhancing the light extraction efficiency.

In the embodiment of the patterned substrate of the present invention as shown in FIG. 2D, the ratio of the area of the platform region to the area of the unit region is less than 10%, so that the adjacent protruded portions could be engaged for enhancing the light extraction efficiency.

FIG. 2E is a top view of another preferred embodiment of the patterned substrate of the present invention. Similarly, in FIG. 2E, each vertex of the triangle as indicated by dotted lines is located in the center of a circle of each of the adjacent protruded portions, the area defined by the triangle is represented by reference numeral A, the area of the platform region is A2, and the area of the protruded portions is A-A2. If the area defined by the triangle as indicated by dotted lines is taken as an unit area, by comparing FIG. 2D with FIG. 2E, it is obvious that the area of the protruded portions A-A2 is larger than the area of the protruded portions A-A1. From the above description, it is understood that in the embodiment of the patterned substrate of the present invention as shown in FIG. 2E, the area of the protruded portions is increased, such that the effective area for refraction is increased, which may remarkably increase the extraction efficiency of the light emitting device. Preferably, in an embodiment of the patterned substrate of the present invention, a ratio of the area of the protruded portions in the unit area is expressed by the following equation (1):

$$\frac{A - A 1}{A} \leq x < 1 \qquad ( 1 )$$

The patterned substrate of the present invention can be formed by a dry etching process or an electron beam etching process. Alternatively, the patterned substrate of the present invention can be formed by a wet etching process with over etching performed. The dry etching, electron beam etching, and wet etching processes should be apparent to those skilled in the art without further explanation.

In the following description, several examples are given to provide a thorough understanding of the process of fabricating a light emitting device by the patterned substrate of the invention.

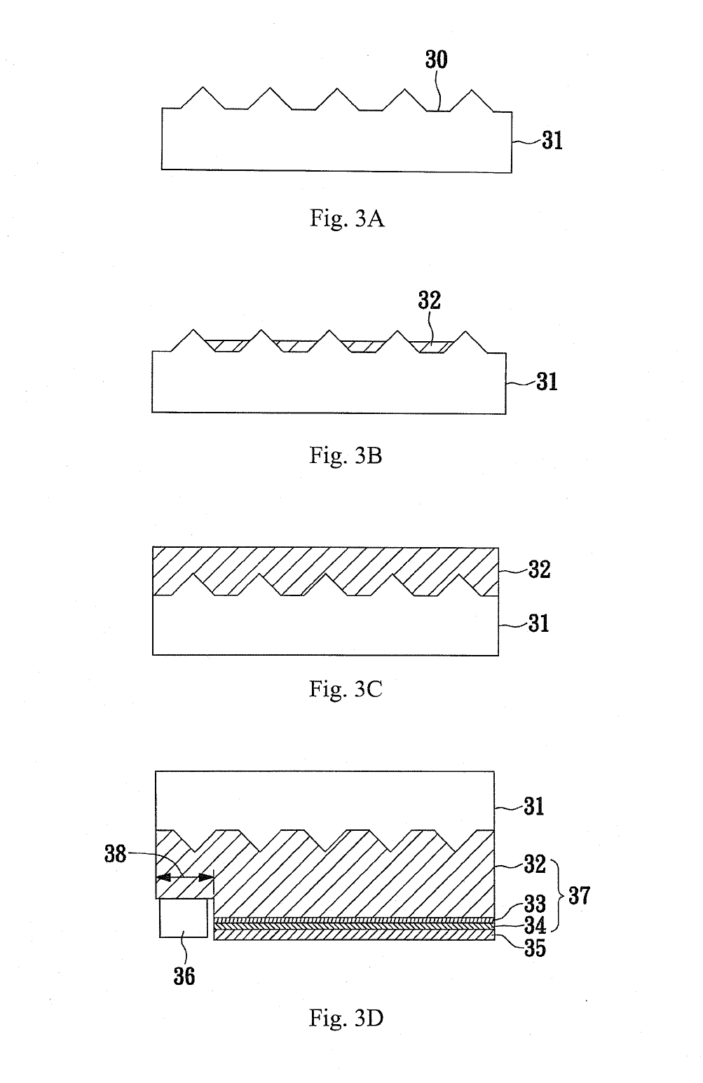

FIGS. 3A to 3D are schematic diagrams showing a production flow of a preferred embodiment of the light emitting device of the present invention. FIG. 3A shows the patterned substrate of the present invention, wherein the plurality of directly adjacent protruded portions have a flat surface. FIG. 3B illustrates the process of forming epitaxial film on the platform region of the patterned substrate. FIG. 3C shows that the epitaxial film is formed with a thickness higher than the height of the protruded portions of the patterned substrate. FIG. 3D illustrates an embodiment of the light emitting device of the present invention, wherein the patterned substrate 31 is vertical-turned, as compared with FIG. 3C, and an epitaxial stacking structure and electrodes are further formed on the epitaxial film 32.

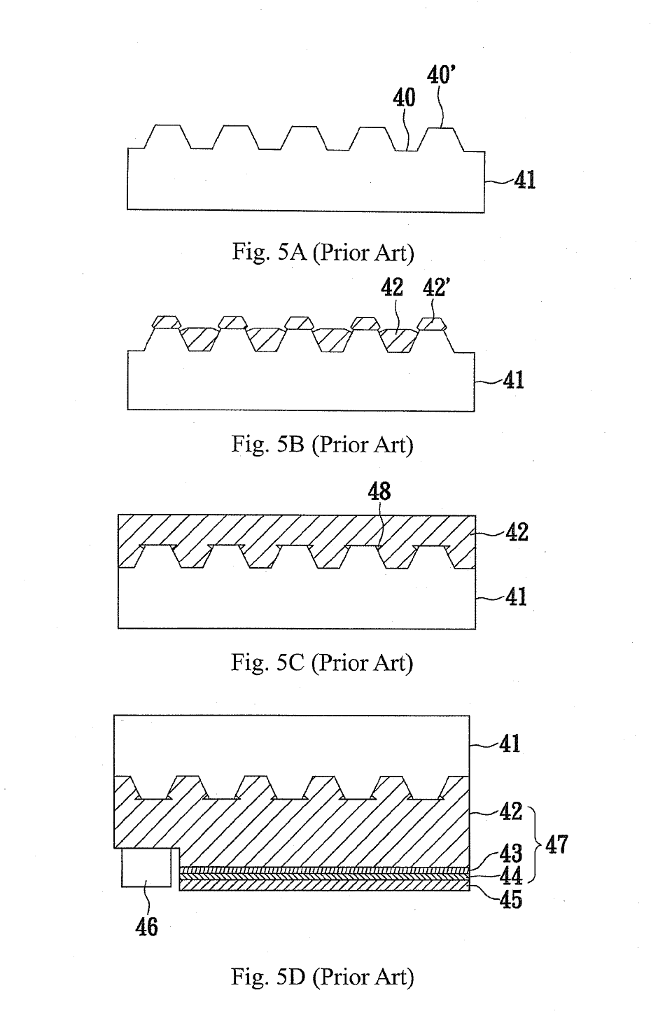

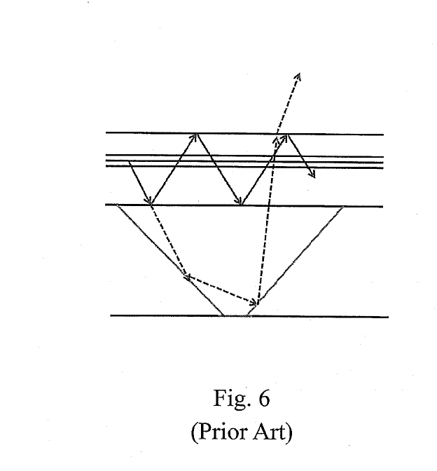

As shown in FIG. 3B, during epitaxial growth, the epitaxial film 32 is mainly formed on the at least one platform region 30 of the patterned substrate 31, which may prevent epitaxial defects as illustrated in FIG. 5B from generating.

FIG. 3D illustrates an embodiment of the light emitting device of the present invention, comprising: a substrate 31 and an epitaxial stacking structure 37 provided on the substrate 31, sequentially comprising a first semiconductor layer 32, a light emitting layer 33, and a second semiconductor layer 34 along a stacking direction, the first semiconductor layer 32 comprising a first portion 38 which is not covered by the light emitting layer 33 and the second semiconductor layer 34; a first electrode 36 engaged with the first portion 38 of the first semiconductor layer 32; and a second electrode 35 engaged with the second semiconductor layer 34 and electrically separated from the first electrode 36.

Preferably, the first semiconductor layer 32 and the second semiconductor layer 34 are formed of GaN. More preferably, the first semiconductor layer 32 is formed of an n-type GaN and the second semiconductor layer 34 is formed of a p-type GaN.

Furthermore, though the embodiment stated above is illustrated by a flip-chip packaging method, the present invention can, however, deviate from the described manner, also be packaged by other LED packaging methods such as conventional wire-bonding method, as long as the effect of increasing external quantum efficiency by the patterned substrate is achieved.

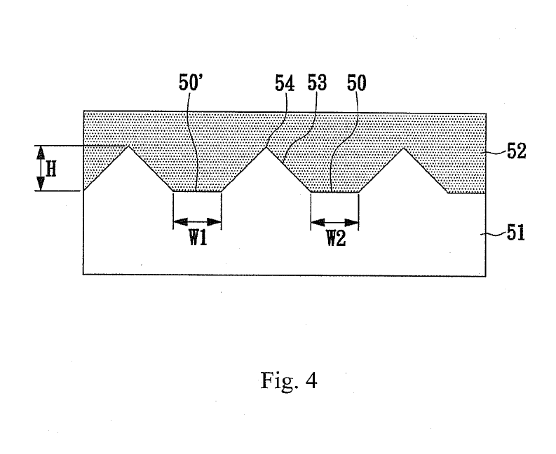

FIG. 4 further illustrates a preferred embodiment of the patterned substrate of the invention. The patterned substrate includes a platform region 50 having a first facet direction for epitaxial growth, for example the (0001) facet direction of C-plane sapphire; and a plurality of directly adjacent protruded portions 53 surrounding the platform region 50 to isolate the platform region 50 from another platform region 50′, wherein facet direction of each scattering surface of the plurality of directly adjacent protruded portions 53 is substantially excluded from first facet direction. The width of the platform region 50 is W1, and the width of the platform region 50′ is W2. A distance from the platform region 50 to the highest point of the protruded portions 53 is H. In the patterned substrate of the invention, W1 and W2 may be the same or different from each other. Preferably, W1 and W2 are the same.

Further, though the examples of the patterned substrate of the invention stated above use a sapphire substrate, the present invention is not limited by these examples. Suitable substrates for growing a Group III-V semiconductor material (for example, Group III nitride semiconductor material, GaN) include but are not limited to Si, SiC, and the like.

Besides, the Group III nitride semiconductor material is not limited to GaN material. As is well understood by those in this art, the Group III elements can combine with nitrogen to form binary compounds such as AlN or InN, tertiary compounds such as AlGaN, or quaternary compounds such as AlInGaN.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. A patterned substrate for fabricating a light emitting device having an improved surface structure, comprising:
at least one platform region having a first facet direction for epitaxial growth; and
a plurality of directly adjacent protruded portions surrounding the at least one platform region to isolate the at least one platform region from another platform region, each directly adjacent protruded portion having a scattering surface and a vertex,
wherein facet direction of each scattering surface of the plurality of directly adjacent protruded portions is substantially excluded from first facet direction,
wherein at least one unit region is surrounded by the vertexs or lines between the adjacent vertexs of the plural directly adjacent protruded portions, an area of the unit region consists of an area of the protruded portions and an area of the platform region, the area of the protruded portion is larger than the area of the platform region.

2. The patterned substrate according to claim 1, wherein each vertex of the plurality of protruded portions has a shape of dot or line.

3. The patterned substrate according to claim 1, wherein the scattering surfaces are formed between the platform region and the vertexs or lines between the adjacent vertexs of the plurality of directly adjacent protruded portions.

4. The patterned substrate according to claim 1, wherein the plurality of directly adjacent protruded portions have a curved surface.

5. The patterned substrate according to claim 1, wherein the plurality of directly adjacent protruded portions have a flat surface.

6. The patterned substrate according to claim 1, wherein the first facet direction is (0001) facet direction for C-plane sapphire.

7. The patterned substrate according to claim 1, wherein the unit region has a shape of hexagon or triangle.

8. The patterned substrate according to claim 1, wherein the ratio of the area of the platform region to the area of the unit region is less than or equal to 10%.

9. A patterned substrate for fabricating a light emitting device having an improved surface structure, comprising:
at least one platform region having a first facet direction for epitaxial growth; and
a plurality of directly adjacent protruded portions surrounding the at least one platform region to isolate the at least one platform region from another platform region, each directly adjacent protruded portion having a scattering surface and a vertex,
wherein each facet direction of the scattering surface of the plurality of directly adjacent protruded portions is substantially excluded from first facet direction,
wherein in top view of the area of the directly adjacent protruded portion for scattering light is larger than the area of the platform region for epitaxial growth.

10. The patterned substrate according to claim 9, wherein each vertex of the plurality of directly adjacent protruded portions has a shape of dot or line.

11. The patterned substrate according to claim 9, wherein the scattering surfaces are formed between the platform region and the vertexs or lines between the adjacent vertexs of the plurality of directly adjacent protruded portions.

12. A patterned substrate for fabricating a light emitting device having an improved surface structure, comprising:
at least one platform region serving as a primary platform for epitaxial growth; and
a plurality of directly adjacent protruded portions surrounding the at least one platform region to isolate the at least one platform region from another platform region, each directly adjacent protruded portion having a scattering surface and a vertex,
wherein at least one unit region is surrounded by the vertexs or lines between the adjacent vertexs of the plural directly adjacent protruded portions, an area of the unit region consists of an area of the protruded portions and an area of the platform region, the area of the protruded portion is larger than the area of the platform region.

13. The patterned substrate according to claim 12, wherein each vertex of the plurality of directly adjacent protruded portions has a shape of dot or line.

14. The patterned substrate according to claim 12, wherein the scattering surfaces are formed between the platform region and the vertexs or lines between the adjacent vertexs of the plurality of directly adjacent protruded portions.

15. The patterned substrate according to claim 12, wherein the unit region has a shape of hexagon or triangle.

16. The patterned substrate according to claim 12, wherein the ratio of the area of the platform region to the area of the unit region is less than or equal to 10%.
